(19) United States
(12) Patent Application Publication
(10) Pub. No.: US 2019/0344764 A1
(43) Pub. Date: Nov. 14, 2019

(54) Distributed Brake Retention and Control System for a Train and Associated Methods

(71) Applicant: Westinghouse Air Brake Technologies Corporation, Wilmerding, PA (US)

(72) Inventors: Jeffrey D. Kernwein, Cedar Rapids, IA (US); James A. Oswald, Coggon, IA (US)

(21) Appl. No.: 15/978,830

(22) Filed: May 14, 2018

(51) Int. Cl. B60T 8/17; B60T 13/38; B60T 15/02

(52) U.S. Cl. CPC B60T 8/1705; B61H 1/00; B60T 15/021; B60T 13/385

(57) ABSTRACT

An airbrake retention system and method for controlling air flow within an airbrake system, including the steps of: receiving, with a computer system comprising one or more processors, train control data associated with stopping on a grade; determining, with a computing system comprising one or more processors, an air retention controller within a railcar brake system to control air pressure release based on the train control data; communicating, with a computing system comprising one or more processors, an air control signal, the air control signal comprising information associated with a retainer valve of the braking assembly; and controlling, with a computing system comprising one or more processors, the retainer valve to adjust from a first state to a second state based on the air control signal to control air flow between the reservoir and the air braking assembly.

### BACKGROUND

### Field of the Invention

The present invention relates generally to braking control systems and arrangements for use in connection with an airbrake arrangement, and in particular to a brake control method and an airbrake arrangement for a train, railcar, railway vehicle, and similar vehicles, and preferably an electronically-controlled pneumatic airbrake retention arrangement for a railway vehicle.

### Description of Related Art

As is known, braking systems and arrangements are required for slowing and stopping vehicles, such as cars, trucks, trains, railcars, railway vehicles, and the like. With specific respect to trains and other railway vehicles, the braking system is normally in the form of a pneumatically-driven arrangement (or “airbrake arrangement”) having mechanisms and components that interact with each railcar.

Airbrakes of a railway airbrake system are operated by controlling air pressure into a brake pipe line. This pressurized air comes from an air compressor in the engine at the origin of the brake pipe and is sent from car to car by a brake pipe line made up of pipes beneath each car and hoses between cars. To move the train, full air pressure is placed in the brake pipe to signal to each car to release or maintain the release of airbrakes. When the engine operator releases the brake, the brake pipe line is charged by a compressor of the locomotive. The subsequent increase of train line pressure causes each car to discharge the contents of the brake cylinder, releasing the brakes and recharging the reservoirs. The engine operator applies the brake by operating a locomotive brake valve, causing the brake pipe line to vent at a controlled rate, reducing the brake pipe line pressure and in turn triggering each car to feed air from a reservoir into its brake cylinder. During application of the airbrakes, air pressure is reduced, the subsequent reduction causes each car to apply its airbrakes, by switching the compressed air stored in an air reservoir to feed air pressure to the brake cylinder. If the pressure in the brake pipe line increases to a point higher than that of the air reservoir, air pressure is directed to the air reservoir. If brake pipe line pressure is lower than that of the air reservoir pressure, air pressure is directed to the brake cylinder.

In some aspects, brake pressure may also be effected by unavoidable leakage, where the tanks can gradually seep air through various connections (e.g., between each car or the components of the airbrake system). Normally, the train's engine is constantly resupplying the railcar's tanks with air, and this slight leakage isn't a problem. However, for trains parked during an extended period without a running engine, leakage may cause loss of braking pressure.

In some aspects, such as while traversing a long mountain grade, air reservoir pressure decreases to the point where actuation of the brake cylinders becomes difficult or fails altogether. For example, if the brakes must be applied before recharging has been completed, a larger brake pipe reduction will be required in order to achieve the desired amount of braking effort, as the system is starting out at a lower point of equilibrium (lower overall pressure). If multiple brake pipe reductions are made in short succession, a point may be reached where car reservoir pressure will be severely depleted, resulting in substantially reduced brake cylinder piston force, causing the brakes to fail. Since fully recharging the reservoirs on a long train can require considerable time (e.g., 8 to 100 minutes in some aspects), during which the brake pipe pressure will be lower than locomotive reservoir pressure, on a descending grade, the unfortunate result of such a severe depletion will be a runaway train. For a time after releasing the brakes, the reservoirs are not fully charged, and an engineer does not have full braking power available.

If brake pipe line pressure is lower than that of the air reservoir pressure, air pressure is directed to the brake cylinder. In such cases, the brake cylinder vent is closed and air from the railway car's reservoir is fed into the brake cylinder. This causes pressure to increase in the brake cylinder, causing application of the brakes, or enough for holding application of the brakes while air is decreasing in the reservoir. This action continues until equilibrium between the brake pipe pressure and reservoir pressure is achieved. As the pressure in the brake pipe line and that of the reservoir equalize, the air pressure is sealed from the brake cylinder, and the brake cylinder is not pressurized. At the equilibrium point, the airflow from the reservoir to the brake cylinder is lapped off and the cylinder is maintained at a constant pressure.

To avoid some of these problems, conventional brake cylinder pressure retainer valves have been employed to control the release of the car brakes independently of the control valves. However, conventional brake cylinder pressure retainer valves are undesirable as they are time consuming to operate. Each time a worker enters the trackside area, an imminent risk of a harm to the worker is created. Such manual solutions also fail to account for environmental conditions and train conditions. They cannot be implemented in a coordinated action. For example, implementation can be imperfect when workers miss a retaining valve inadvertently. For example, before descending long grades, manual brake cylinder pressure retainer valves are set in order to maintain a limited braking force during a brake release, while the brake pipe and associated reservoirs are being recharged in preparation for a subsequent brake application. The setting operation requires field workers to traverse the train along the tracks and use a handle which actuates the brake cylinder pressure retainer valve.

There exists a need in the industry to reduce the need for the crew to manually apply the retainer valves. This is primarily based upon the desire to reduce the risk of injury to the crew involved in such manual field operations. This need is also rising due to the extensive time commitment for such manual solutions to account for environmental conditions and train conditions and lack of a coordinated action. This need is also rising with the trend towards single person-operated trains, with some railroads planning for future unmanned operations. Also, manual implementation can be imperfect when workers miss a retaining valve inadvertently.

### SUMMARY OF THE INVENTION

According to some non-limiting embodiments or aspects, provided is an airbrake cylinder retention method for a train equipped with an airbrake system and comprising at least one locomotive, at least one head-end controller unit, a brake pipe, and at least one brake cylinder, includes receiving, with at least one processor, train control data in the head-end controller unit, the train control data associated with a control input for operating the airbrake system of a train in a track segment including a grade; identifying, with at least one processor, at least one air retention device of the airbrake system based on the train control data; communicating, with at least one processor, at least one air control signal from the head-end controller unit to the at least one identified air retention device, the at least one identified air retention device comprising a controller to receive a control signal and a valve to control exhaust release from the at least one airbrake cylinder, where the air control signal includes instructions for at least one identified air retention device; and controlling, with at least one processor, a valve state of the at least one identified air retention device to adjust from a first state to a second state based on the air control signal, and the first state represents a vent state, to allow exhaust from the airbrake cylinder, and the second state represents a hold state, to retain air flow exhaust in the at least one airbrake cylinder.

In some non-limiting embodiments or aspects, the method further comprises, when identifying at least one air retention device of the airbrake system, linking, with at least one processor, at least one air retention device to an in-train network comprising a plurality of self-identifying nodes, the self-identifying nodes coupled to the head-end controller unit; communicating to one or more of the self-identifying nodes, valve data from the head-end controller unit to the at least one air retention device, the valve data comprising destination information, where the destination information identifies the head-end controller; and in response to communicating the valve data, receiving, with at least one processor, valve data in the head-end controller unit from at least one of the one or more self-identifying nodes, and the valve data identifies the at least one air retention device.

In some non-limiting embodiments or aspects, the method further comprises, when communicating valve data from the head-end controller unit to the at least one air retention device, transmitting, with at least one processor, valve data from the air retention device to a second air retention device configured to determine an intermediate self-identifying node of the one or more self-identifying nodes and communicate the valve data to the intermediate self-identifying node.

In some non-limiting embodiments or aspects, the at least one identified air retention device comprises a stand-by state and the method further comprises receiving, with at least one processor, an air control signal from the head-end controller unit, the air control signal comprising information associated with awakening the air retention device from a stand-by state; and in response to receiving the air control signal, generating, with at least one processor, a predetermined duration for active communication; and enabling operation, with at least one processor, of the controller of the at least one identified air retention device based on the air control signal and the predetermined duration for active communication.

In some non-limiting embodiments or aspects, the method further comprises generating, with at least one processor, a logical association of one or more railway cars with at least one air retention device; processing, with at least one processor, control input for operating at least one air retention device in the logical association; adjusting, with at least one processor, a status in the head-end controller unit associated with the at least one air retention device based on the control input; and outputting, with at least one processor, a representation of the logical association of the at least one air retention device and status.

In some non-limiting embodiments or aspects, when determining an air retention device for controlling air flow within an airbrake system to prevent air pressure release based on the train control data, further comprises determining, with at least one processor, one or more railway cars associated with a braking event, where the one or more railway cars are associated with at least one air retention device to prevent a runaway condition on a grade.

In some non-limiting embodiments or aspects, the train control data includes a brake force prediction from a train control system associated with at least one upcoming track segment based on external conditions and train control factors and the method further comprises predicting a threshold number of air retention device nodes to activate based on the train control data; and communicating, with at least one processor, at least one air control signal to one or more air retention devices based on the brake force prediction.

In some non-limiting embodiments or aspects, the method further comprises automatically controlling an air retention device when approaching a grade based on train control data.

In some non-limiting embodiments or aspects, the method further comprises communicating, with at least one processor, a sleep signal from the head-end unit to at least one air retention device, the sleep signal activating a stand-by state of the controller of the at least one retaining valve; and awakening, with at least one processor, the at least one retaining valve to receive control signals based on reaching a brake pressure threshold value.

In some non-limiting embodiments or aspects, the step of controlling the air retention device to adjust from a first state to a second state is based on air pressure for pneumatically moving the air retention device from a release state (e.g., a position of the valve where air may flow without restriction) to a hold state (e.g., a position of the valve where air may not flow and/or may flow with restriction).

According to some non-limiting embodiments or aspects, provided is an airbrake retention system for a train equipped with an airbrake system and comprising at least one locomotive, a brake pipe coupled to at least one railcar, at least one airbrake cylinder, and an exhaust pipe from the airbrake cylinder, the system including a wireless head-end controller unit programmed or configured to: receive train control data associated with a control input for operating the airbrake system of a train in a track segment including a grade; identify at least one air retention device based on the train control data; and communicate at least one air control signal to the at least one identified air retention device; and the system further including at least one air retention device, comprising a pneumatically adjustable valve portion coupled to the exhaust pipe of the airbrake cylinder to control exhaust release from the at least one airbrake cylinder; and a controller comprising at least one processor, the controller programmed or configured to receive an air control signal including instructions for adjusting a state of the at least one identified air retention device; and control a valve state of the pneumatically adjustable valve portion to adjust from a first state to a second state based on the air control signal, and the first state represents a vent state to allow exhaust from the airbrake cylinder, and the second state represents a hold state to retain air flow exhaust in the at least one airbrake cylinder.

In some non-limiting embodiments or aspects, the train further comprises an in-train network, the controller of the at least one air retention device further programmed or configured to: link at least one air retention device to an in-train network comprising a plurality of self-identifying nodes, the self-identifying nodes coupled to the head-end controller unit; and the wireless head-end controller unit is further programmed or configured to communicate valve data from the head-end controller unit to the at least one air retention device, the valve data comprising destination information, where the destination information identifies the head-end controller; and in response to communicating the valve data, receive valve data in the head-end controller unit from at least one of the one or more self-identifying nodes, where the valve data identifies the at least one air retention device.

In some non-limiting embodiments or aspects, the wireless head-end controller unit is coupled to the in-train network, and the wireless head-end controller unit when identifying at least one air retention device of the airbrake system is further programmed or configured to receive valve data in the head-end controller unit from one or more self-identifying nodes of the in-train network, and where the valve data identifies the at least one air retention device.

In some non-limiting embodiments or aspects the at least one air retention device comprises a stand-by state, the air retention device further programmed or configured to receive an air control signal from the head-end controller unit, the air control signal comprising information associated with awakening the air retention device from a stand-by state; and in response to receiving the air control signal: the air retention device is further programmed or configured to generate, with at least one processor, a predetermined duration for active communication; and enable operation of the controller of the at least one air retention device based on the air control signal and the predetermined duration for active communication.

In some non-limiting embodiments or aspects, the wireless head-end controller unit is further programmed or configured to generate a logical association of one or more railway cars with at least one air retention device; process control input for operating at least one air retention device in the logical association; adjust a status in the head-end controller unit associated with the at least one air retention device based on the control input; and output a representation of the logical association of the at least one air retention device and status.

In some non-limiting embodiments or aspects, the head-end controller unit, when determining an air retention device for controlling air flow within an airbrake system, is further programmed or configured to determine one or more railway cars associated with a braking event, where the one or more railway cars are associated with at least one air retention device to prevent a runaway condition on a grade.

In some non-limiting embodiments or aspects, the train control data includes a brake force prediction from a train control system associated with at least one upcoming track segment based on external conditions and train control factors, the wireless head-end controller unit is further programmed or configured to predict a threshold number of air retention device nodes to activate based on the train control data; and communicate at least one air control signal to one or more air retention devices based on the brake force prediction.

In some non-limiting embodiments or aspects, the system automatically controlling the air retention device when approaching a grade based on train control data.

In some non-limiting embodiments or aspects, the system awakens the controller of the air retention device to receive control signals based on reaching a brake pressure threshold value.

In some non-limiting embodiments or aspects, the air retention device is programmed or configured to adjust from a first state to a second state based on air pressure for pneumatically moving the pneumatically adjustable valve portion of the air retention device from a release state to a hold state.

According to some non-limiting embodiments or aspects, a computer program product for controlling air flow within an airbrake system, includes a first non-transitory computer-readable medium including program instructions that, when executed by at least one processor, causes the at least one processor to receive train control data associated; determine an air retention device within a railcar brake system to control airbrake release based on the train control data; and communicate an air control signal, the air control signal comprising information associated with an air retention device of an air braking system; and includes a second non-transitory computer-readable medium including program instructions that, when executed by at least one processor, causes the at least one processor to control at least one air retention device to receive an air control signal including instructions for adjusting a state of a pneumatically adjustable valve portion of at least one air retention device; and control a valve state of the pneumatically adjustable valve portion to adjust from a first state to a second state based on the air control signal, where the first state represents a vent state to allow exhaust from the airbrake cylinder, and the second state represents a hold state to retain air flow exhaust in the at least one airbrake cylinder.

Further non-limiting embodiments or aspects are set forth in the following numbered clauses:

Clause 1: An airbrake cylinder retention method for a train equipped with an airbrake system and comprising at least one locomotive, at least one head-end controller unit, a brake pipe, and at least one brake cylinder, includes receiving, with at least one processor, train control data in the head-end controller unit, the train control data associated with a control input for operating the airbrake system of the train in a track segment including a grade; identifying, with at least one processor, at least one air retention device of the airbrake system based on the train control data; communicating, with at least one processor, at least one air control signal from the head-end controller unit to the at least one identified air retention device, the at least one identified air retention device comprising a controller to receive a control signal and a valve to control exhaust release from the at least one airbrake cylinder, wherein the air control signal includes instructions for the at least one identified air retention device; and controlling, with at least one processor, a valve state of the at least one identified air retention device to adjust from a first state to a second state based on the air control signal, wherein the first state represents a vent state, to allow exhaust from the airbrake cylinder, and the second state represents a hold state, to retain air flow exhaust in the at least one airbrake cylinder.

Clause 2: The airbrake cylinder retention method of clause 1, further comprising: when identifying the at least one air retention device of the airbrake system, linking, with at least one processor, the at least one air retention device to an in-train network comprising a plurality of self-identifying nodes, the self-identifying nodes coupled to the head-end controller unit; communicating to one or more of the self-identifying nodes, valve data from the head-end controller unit to the at least one air retention device, the valve data comprising destination information, wherein the destination information identifies the head-end controller; and in response to communicating the valve data, receiving, with at least one processor, valve data in the head-end controller unit from at least one of the one or more self-identifying nodes, wherein the valve data identifies the at least one air retention device.

Clause 3: The airbrake cylinder retention method of clauses 1-2, further comprising: when communicating valve data from the head-end controller unit to the at least one air retention device, transmitting, with at least one processor, valve data from the at least one air retention device to a second air retention device configured to determine an intermediate self-identifying node of the one or more of the self-identifying nodes and communicate the valve data to the intermediate self-identifying node.

Clause 4: The airbrake cylinder retention method of any of clauses 1-3, further comprising: when the at least one identified air retention device, receiving, with at least one processor, an air control signal from the head-end controller unit, the air control signal comprising information associated with awakening the at least one air retention device from the stand-by state; and in response to receiving the air control signal, generating, with at least one processor, a predetermined duration for active communication; and enabling operation, with at least one processor, of the controller of the at least one identified air retention device based on the air control signal and the predetermined duration for active communication.

Clause 5: The airbrake cylinder retention method of any of clauses 1-4, further comprising: generating, with at least one processor, a logical association of one or more railway cars with the at least one air retention device; processing, with at least one processor, control input for operating the at least one air retention device in the logical association; adjusting, with at least one processor, a status in the head-end controller unit associated with the at least one air retention device based on the control input; and outputting, with at least one processor, a representation of the logical association of the at least one air retention device and status.

Clause 6: The airbrake cylinder retention method of any of clauses 1-5, further comprising: when determining the at least one air retention device for controlling air flow within the airbrake system to prevent air pressure release based on the train control data, further comprises: determining, with at least one processor, one or more railway cars associated with a braking event, wherein the one or more railway cars are associated with the at least one air retention device to prevent a runaway condition on the grade.

Clause 7: The airbrake cylinder retention method of any of clauses 1-6, further comprising train control data that includes a brake force prediction from a train control system associated with at least one upcoming track segment based on external conditions and train control factors and the method further comprises: predicting a threshold number of air retention device self-identifying nodes to activate based on the train control data; and communicating, with at least one processor, at least one air control signal to one or more air retention devices based on the brake force prediction.

Clause 8: The airbrake cylinder retention method of any of clauses 1-7, further comprising: automatically controlling the at least one air retention device when approaching a grade based on train control data.

Clause 9: The airbrake cylinder retention method of any of clauses 1-8, further comprising: communicating, with at least one processor, a sleep signal from the head-end unit to at least one air retention device, the sleep signal activating a stand-by state of the controller of the at least one retaining valve; and awakening, with at least one processor, the at least one retaining valve to receive control signals based on reaching a brake pressure threshold value.

Clause 10: The airbrake cylinder retention method of any of clauses 1-9, further comprising: controlling the at least one air retention device to adjust from the first state to the second state is based on air pressure for pneumatically moving the at least one air retention device from a release state to a hold state.

Clause 11: An airbrake retention system for a train equipped with an airbrake system and comprising at least one locomotive, a brake pipe coupled to at least one railcar, at least one airbrake cylinder, and an exhaust pipe from the airbrake cylinder, the system including a wireless head-end controller unit programmed or configured to receive train control data associated with a control input for operating the airbrake system of a train in a track segment including a grade; identify at least one air retention device based on the train control data; and communicate at least one air control signal to the at least one identified air retention device; and the system further including the at least one air retention device, comprising a pneumatically adjustable valve portion coupled to the exhaust pipe of the airbrake cylinder to control exhaust release from the at least one airbrake cylinder; and a controller comprising at least one processor, the controller programmed or configured to receive an air control signal including instructions for adjusting a state of the at least one identified air retention device; and control a valve state of the pneumatically adjustable valve portion to adjust from a first state to a second state based on the air control signal, wherein the first state represents a vent state to allow exhaust from the airbrake cylinder, and the second state represents a hold state to retain air flow exhaust in the at least one airbrake cylinder.

Clause 12: The computing system of clause 11, wherein the train further comprises an in-train network, the controller of the at least one air retention device is further programmed or configured to: link the at least one air retention device to the in-train network comprising a plurality of self-identifying nodes, the self-identifying nodes coupled to the head-end controller unit; wherein, the wireless head-end controller unit programmed or configured to: communicate valve data from the head-end controller unit to the at least one air retention device, the valve data comprising destination information, wherein the destination information identifies the head-end controller; and in response to communicating the valve data, receive valve data in the head-end controller unit from at least one of the one or more self-identifying nodes, wherein the valve data identifies the at least one air retention device.

Clause 13: The computing system of clauses 11-12, wherein the wireless head-end controller unit is coupled to the in-train network, the wireless head-end controller unit when identifying the at least one air retention device of the airbrake system is further programmed or configured to: receive valve data in the head-end controller unit from one or more self-identifying nodes of the in-train network, wherein the valve data identifies the at least one air retention device.

Clause 14: The computing system of any of clauses 11-13, wherein the at least one air retention device comprises a stand-by state, the at least one air retention device further programmed or configured to: receive an air control signal from the head-end controller unit, the air control signal comprising information associated with awakening the at least one air retention device from the stand-by state; in response to receiving the air control signal: generate, with at least one processor, a predetermined duration for active communication; and enable operation of the controller of the at least air retention device based on the air control signal and the predetermined duration for active communication.

Clause 15: The computing system of any of clauses 11-14, the wireless head-end controller unit is further programmed or configured to: generate a logical association of one or more railway cars with the at least one air retention device; process control input for operating the at least one air retention device in the logical association; adjust a status in the head-end controller unit associated with the at least one air retention device based on the control input; and output a representation of the logical association of the at least one air retention device and status.

Clause 16: The computing system of any of clauses 11-15, wherein the head-end controller unit, when determining the at least one air retention device for controlling air flow within an airbrake system, is further programmed or configured to: determine one or more railway cars associated with a braking event, wherein the one or more railway cars are associated with the at least one air retention device to prevent a runaway condition on the grade

Clause 17: The computing system of any of clauses 11-16, wherein the train control data includes a brake force prediction from a train control system associated with at least one upcoming track segment based on external conditions and train control factors, the wireless head-end controller unit is further programmed or configured to: predict a threshold number of air retention device self-identifying nodes to activate based on the train control data; and communicate at least one air control signal to one or more air retention devices based on the brake force prediction.

Clause 18: The computing system of any of clauses 11-17, comprising automatically controlling the at least one air retention device when approaching the grade based on train control data.

Clause 19: The computing system of any of clauses 11-18, further comprising: awakening the controller of the at least one air retention device to receive control signals based on reaching a brake pressure threshold value.

Clause 20: The computing system of clause 11-19, wherein the air retention device is programmed or configured to adjust from the first state to the second state is based on air pressure for pneumatically moving the pneumatically adjustable valve portion of the at least one air retention device from a release state to a hold state.

Clause 21: A computer program product for controlling air flow within an airbrake system, includes a first non-transitory computer-readable medium including program instructions that, when executed by at least one processor, causes the at least one processor to receive train control data associated; determine an air retention device within a railcar brake system to control airbrake release based on the train control data; and communicate an air control signal, the air control signal comprising information associated with the air retention device of an air braking system; and includes a second non-transitory computer-readable medium including program instructions that, when executed by at least one processor, causes the at least one processor to control at least one air retention device to receive an air control signal including instructions for adjusting a state of a pneumatically adjustable valve portion of the at least one air retention device; and control a valve state of the pneumatically adjustable valve portion to adjust from a first state to a second state based on the air control signal, wherein the first state represents a vent state to allow exhaust from the airbrake cylinder, and the second state represents a hold state to retain air flow exhaust in the at least one airbrake cylinder.

### BRIEF DESCRIPTION OF THE DRAWINGS

FIG. 1 is a schematic view of an airbrake retention arrangement for a train;

FIG. 2 is a schematic diagram of a non-limiting embodiment of an environment in which systems and/or methods, described herein, may be implemented;

FIG. 3 is a diagram of a non-limiting embodiment of components of one or more devices of FIGS. 1 and 2;

FIG. 4 is a schematic view of a further embodiment of an airbrake retention system for an airbrake arrangement according to the principles of the present invention;

FIG. 5 is a diagram of an in-train network for controlling airbrake retention;

FIG. 6 is a flowchart of a non-limiting embodiment of a process for predicting parking locations based on image data;

FIG. 7 is a flowchart of a non-limiting embodiment of a process for generating one or more prediction scores associated with one or more elements in a multi-dimensional matrix of an image; and

FIGS. 8A-8B are diagrams of an implementation of a non-limiting embodiment of a process disclosed herein.

### DESCRIPTION OF THE INVENTION

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

The control system and computer-implemented control method described and claimed herein may be implemented in a variety of systems and vehicular networks; however, the systems and methods described herein are particularly useful in connection with a railway system and network. The systems and methods described herein are useful in connection with and/or at least partially implemented on one or more head-end cars (e.g., locomotives L or control cars that make up a train TR). It should be noted that multiple locomotives or control cars may be included in the train TR to facilitate the reduction of the train TR to match with passenger (or some other) demand or requirement. Further, the method and systems described herein can be used in connection with commuter trains, freight trains, push-pull train configurations, and/or other train arrangements and systems. Still further, the train TR may be separated into different configurations (e.g., other trains TR) and moved in either a first direction A and/or a second direction B. Any configuration or arrangement of locomotives, control cars, and/or railroad cars may be designated as a train and/or a consist. Still further, it is to be expressly understood that the presently-invented methods and systems described herein may be implemented on and/or used in connection with an auxiliary vehicle, such as an auxiliary railroad vehicle, a maintenance vehicle or machine, a road vehicle (e.g., truck, pick-up truck, car, or other machine), a vehicle equipped to ride on the rails of the track, and/or the like.

In some non-limiting embodiments or aspects, the methods and systems described herein are used in connection with the locomotives or controls cars, that are positioned on each end of the train TR, while in some non-limiting embodiments, the methods and systems described herein are used in connection with locomotives that are positioned intermediately in the train TR (since these intermediate locomotives may eventually become a controlling locomotive when the train TR is reconfigured). Still further, the train TR may include only one locomotive and/or some or no railroad cars. Also, as discussed above, the methods and systems described herein may be used in connection with any vehicle type operating in the railway network.

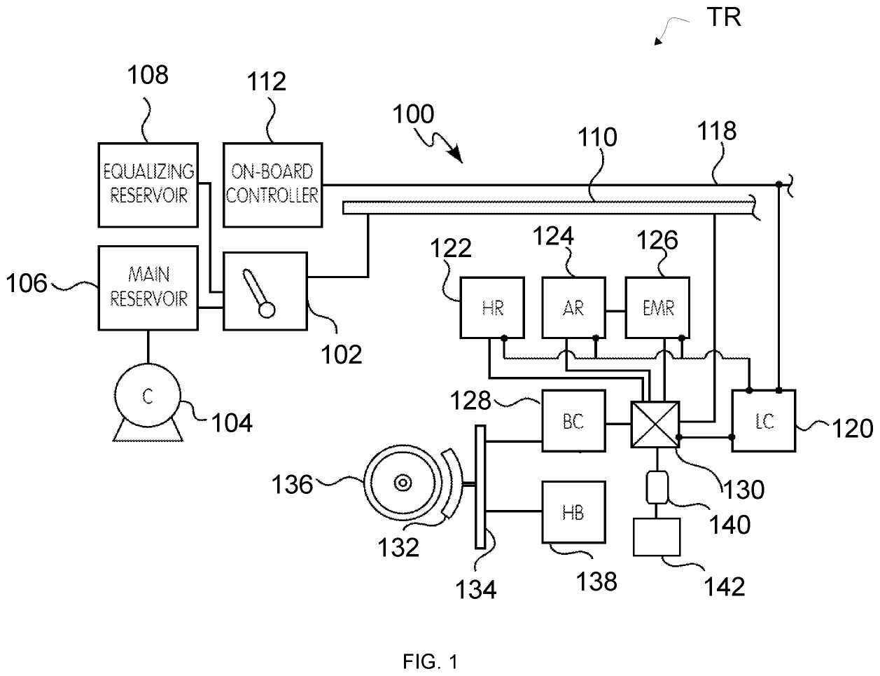

Referring now to FIG. 1, FIG. 1 is a schematic view of a non-limiting embodiment of a braking arrangement 100 of a train. In some non-limiting embodiments, the operator of a train also has control over the braking arrangement 100 through the use of an operator control valve 102. Through the movement of a handle associated with the control valve 102, the operator can adjust the amount of braking to be applied in the airbrake arrangement 100. The higher the braking force selected, the faster the braking arrangement 100 will attempt to slow and stop the train TR. Alternatively, and as discussed in more detail hereinafter, the airbrake arrangement 100 for each railcar may also be controlled by the operator from an on-board controller 112 that transmits data signals over a trainline 118 (or cable extending between the locomotive and the railcars), which may be referred to as an electronically-controlled pneumatic (ECP) airbrake arrangement.

In order to provide the appropriately compressed air to the system, and in certain conventional airbrake applications, the airbrake arrangement 100 also includes a compressor 104 for providing compressed air to a main reservoir 106, which is in communication with the control valve 102. Further, an equalizing reservoir 108 is also in communication with the control valve 102. Whether through the main reservoir 106 or the equalizing reservoir 108, compressed air is supplied through the control valve 102 to a brake pipe 110 that extends along and is associated with each railcar. Each railcar includes an arrangement that allows an auxiliary reservoir 124 to be charged with air via an AB control valve 130, as well as a braking assembly or unit, such as a brake cylinder 128, which is in communication with the valve 130. The brake cylinder 128 is operable to urge a brake shoe mechanism 132, passing pressure through a brake beam 134, against a surface of the wheel 136.

In operation, the brake pipe 110 is continually charged to maintain a specific pressure, e.g., 90 psi, and each auxiliary reservoir 124 and emergency reservoir 126 (which may be combined into a single volume, or main reservoir) are similarly charged from the brake pipe 110. In order to brake the train TR, the operator actuates the control valve 102 and removes air from the brake pipe 110, thereby reducing pressure to a lower level, e.g., 80 psi. The valve 130 quits charging the auxiliary reservoir 124 and transfers air from the auxiliary reservoir 124 to the brake cylinder 128. Normally using piston-operable arrangement, the brake cylinder 128 urges the brake shoe mechanism 132 against the wheel 136. To move the train, the operator actuates the control valve 102 to place full air pressure in the brake pipe 110 to signal (e.g., control) to the valve 130 of each railcar to release and/or maintain the release of airbrake arrangement 100. When the operator releases the brake, the brake pipe 110 is charged by the compressor 104 of the locomotive. The subsequent increase of pressure in the brake pipe 110 causes the valve 130 of each railcar to close off air from the auxiliary reservoir 124 and to discharge the contents of the brake cylinder 128 through the valve 130 into an exhaust pipe passing through a manual retainer valve 140, before passing an air retention device 142, releasing the brakes and recharging the reservoirs. The air retention device, electro-pneumatic in configuration, which is retrofitable to one or more of the fully pneumatic valves of the airbrake arrangement 100 (e.g., the manual retainer valve 140), may block or restrict the air passage. Multiple brake pipe reductions made in short succession may cause a severely depleted auxiliary reservoir 124 pressure reducing force in the brake cylinder 128. In some cases, severe depletion may reduce the pressure that the brake shoe 132 applies, resulting in a failure to slow or stop the wheel 136.

In conventional, non-ECP airbrake systems, the operator may adjust the level of braking using the control valve 102, since the amount of pressure removed from the brake pipe 110 results in a specific pressure in the brake cylinder 128, which results in a specific application force of the brake shoe 132 against the wheel 136. Alternatively, in the ECP airbrake arrangements, the brake commands are electronic over the ECP trainline 118 to a local controller 120 of each railcar.

Using the above-described airbrake arrangement, the train can be slowed and/or stopped during operation as it traverses the track. Further, each railcar is equipped with a manual parking brake 138 for securing each car when parked or stopped, and in order to ensure that the train does not move or shift. Still further, certain railcars may be equipped with a hatch reservoir 122 to provide air to a pneumatically-operable hatch or door of the railcar.

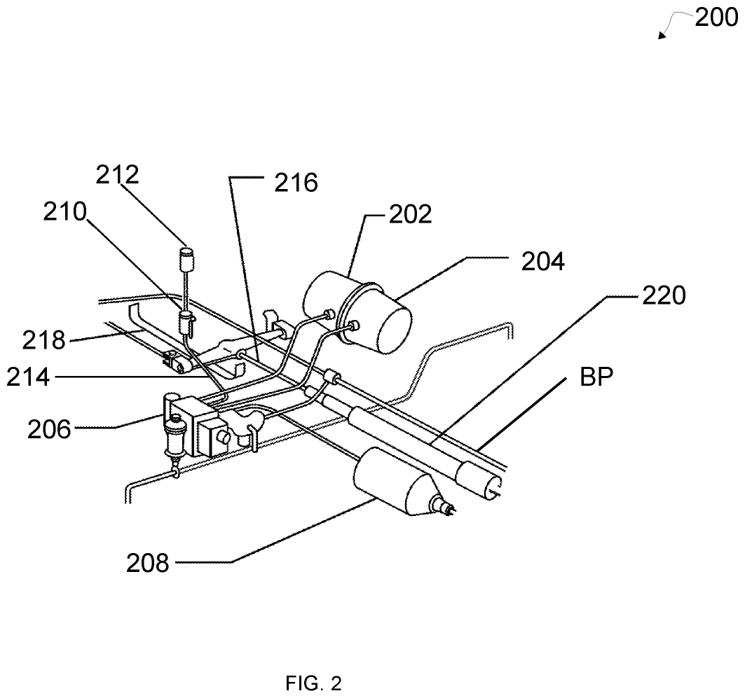

Referring now to FIG. 2, FIG. 2 is a schematic diagram of a non-limiting embodiment of an airbrake retention arrangement 200 according to the principles of the present invention. The airbrake retention arrangement 200 may include a pneumatic operating unit, which is made up of one or more pneumatic operating subunits, which are mechanical assemblies of pneumatic valves, pneumatic tubes, electronically controlled valves, and/or the like. The pneumatic operating subunits may include, but are not limited to, an emergency reservoir 202, an auxiliary reservoir 204, AB control valve 206, brake cylinder 208, retainer valve 210, air retention device 212, or any combination thereof. The pneumatic operating subunits are directly or indirectly connected by one or more pneumatic connections. The pneumatic connections may include, but are not limited to a brake pipe (BP). The pneumatic connections may be part of a pre-existing configuration of the train for which the system is installed, including additional braking components such as center rod 216, lever carrier 218, slack adjuster 220, or other additional systems of the airbrake arrangement 200.

In some non-limiting embodiments, as discussed, the operator of a train has control over the railcar brake arrangement 200 to adjust the amount of braking to be applied in the railcar brake arrangement 200. The brake cylinder 208 is exhausted through exhaust pipe 214 leading to the airbrake retention device 212 (e.g., pneumatically operated retainer valve and electric controller) that can selectively control the release of the brake cylinder 208 independently of the control valve 206 and retainer valve 210 when descending long grades or in other cases, in order to maintain braking force during a brake release, while the brake pipe and associated reservoirs are being recharged in preparation for a subsequent brake application. Airbrake retention device 212 may include an inlet port to which the brake cylinder exhaust air is connected and an outlet port via which the brake cylinder exhaust may be vented to atmosphere, such as through a connection (e.g., serially) to the usual brake exhaust port of the railcar brake system 200. The airbrake retention device 212 may include a valve (e.g., pilot type valve, shuttle type valve, etc.) that may be activated by air pressure to transition from a specified state (e.g., exhaust, release, awaken, etc.), or alternatively variations for incrementally limiting exhaust to vary the rate of flow of brake cylinder exhaust air from the inlet port to the outlet port for limiting the release of brake cylinder exhaust air to a certain chosen pressure in a predetermined one of the different states of airbrake retention.

With continued reference to FIG. 2, to release the brakes on the train's cars, the brake pipe pressure is reduced, e.g., 80 psi. Upon reduction, the auxiliary reservoir 204 begins to recharge; a process that may require a period of time. In some cases, the period of time to recharge may include a period of time before the auxiliary reservoir 204 is fully charged, when an operator may not have full braking power available. When the auxiliary reservoir 204 is not fully charged, a larger brake pipe reduction may be required in order to achieve the desired amount of braking effort, as the system is starting out at a lower point of equilibrium (lower overall pressure). The air retention device 212 may be operated to control brake cylinder pressure. For example, the air retention device 212 may be operated to avoid losing braking pressure. For example, the air retention device 212 may be activated, before or during traversal of a grade. The air retention device can be activated if one or more brake pipe line reductions are needed (e.g., predicted).

In some non-limiting embodiments, the air retention device may be activated to avoid a point where a railcar' s reservoir pressure will be severely depleted. In this way, the air retention device 212 may be activated to avoid reduced brake cylinder force that may reduce or eliminate braking force. The air retention device 212 may prevent exhaust air from the railcar brake cylinder 208 from exiting (e.g., venting to atmosphere). For example, the air retention device 212 may prevent the airbrake cylinder 208 from exiting as the train operates on a grade (e.g., up a graded track, down a graded track, initiating movement on a graded track) before the brakes can be recharged. In this way, the air retention device 212 may be used to prevent a runaway train

In some non-limiting embodiments, the air retention device 212 may operate pneumatically via air intake (e.g., pilot air from a locomotive). For example, to reduce power consumption, the air retention device 212 may use mechanical pressure to activate. In some cases, air retention device 212 may receive air pressure from one or more of the pneumatic subunits to pneumatically activate airbrake retention device 212 after a certain pressure is reached (say 20 psi) in the brake cylinder 208.

In some non-limiting embodiments, the air retention device 212 may change state (e.g., awaken or sleep) based on a predetermined condition in the railcar brake system 200. For example, the air retention device 212 may activate when a predetermined pressure is reached in one or more of the brake pipe, emergency reservoir 202, auxiliary reservoir 204, AB control valve 206, and/or brake cylinder 208, or any combination thereof. In some cases, on awakening, the air retention device 212 may trigger one or more processes to perform.

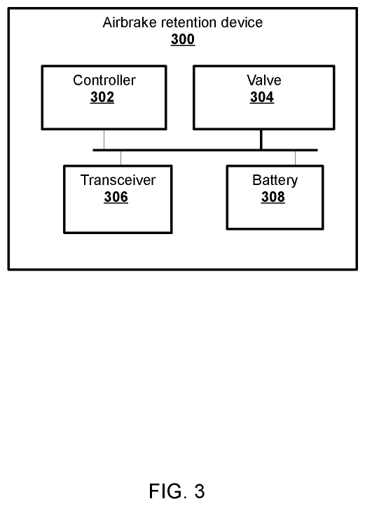

Referring now to FIG. 3, FIG. 3 is a diagram of a non-limiting embodiment of an air retention device 300 according to the principles of the invention. In some non-limiting embodiments, the air retention device 300 is made up of one or more components in combination, which are processing, storage, communication, electrical components, and/or the like. The one or more components of the air retention device 300 may include, but are not limited to an air retention device controller 302, a valve 304, a transceiver 306, and a replaceable battery or power source 308, or any combination thereof.

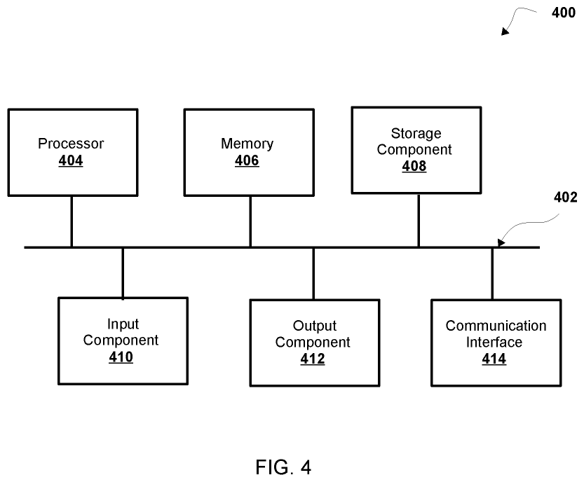

In some non-limiting embodiments, air retention device controller 302 is capable of receiving, storing, and/or providing air control data (e.g., retainer valve data) associated with an air control signal for a railcar brake cylinder 208, where the air control data may include one or more of retention data, release data, or wake-up data. For example, air retention device controller 302 may include one or more computing systems comprising one or more processors (e.g., one or more servers, etc.) and memory (e.g., volatile and/or non-volatile) for controlling the valve 304 (e.g., a pilot valve or shuttle valve). In some non-limiting embodiments, air retention device controller 302 is associated with information stored in the on-board controller 112. For example, information associating a brake cylinder with an air retention device 300 may be stored and/or used to control an air retention device 300 based on the association. Further details regarding a non-limiting embodiment of air retention device controller 302 are provided below with regard to FIGS. 3 and 4.

In some non-limiting embodiments, the transceiver 306 may receive information through the use of a wireless network (e.g., a mesh network implemented with multiple communication devices positioned on each railcar R, which send and receive control signals to a head-end controller (or central dispatch system)). Of course, this wireless communication may occur through a cellular format, a satellite format, and/or any other type of effective data radio transmission, with the ability to communicate to the head-end controller.

In some non-limiting embodiments, transceiver 306 includes communication with one or more wired and/or wireless networks. For example, transceiver 306 may include an Ethernet interface, an optical interface, a coaxial interface, an infrared interface, a radio frequency (RF) interface, a universal serial bus (USB) interface, a Wi-Fi interface (Zigbee), a cellular network interface, and/or the like. Transceiver 306 may further communicate with a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

In some non-limiting embodiments, the air retention device controller 302, valve 304, and the transceiver 306 are electrically coupled and operate off of a DC power (e.g., battery 308) in any convenient manner. A separate replaceable power supply provided with the air retention device 300 may be provided to enable easy battery replacement should that become necessary.

In some non-limiting embodiments, the valve 304 can rely on air pressure and/or electrical power. For example, actuation could be accomplished by one or both of wireless/battery or pneumatic modes. Either or both of the modes would be initiated by the engineer in the locomotive. In some non-limiting embodiments, the valve 304 can rely on air pressure to actuate between states. In some non-limiting embodiments, valve 304 can use a mechanical pressure switch to pneumatically awaken electrical components of the air retention device 300 (e.g., air retention device controller 302, valve 304, the transceiver 306, and any combination thereof). In some cases, the valve 304 would use air pressure to operate (e.g., actuate) the valve pneumatically between states (e.g., open, close, awake, sleep, and/or the like).

Referring now to FIG. 4, FIG. 4 is a diagram of example components of a device 400. Device 400 may correspond to one or more devices of railcar airbrake arrangement 100 or an airbrake retention device 300. For example, device 400 may correspond to an on-board controller 112 (e.g., a head-end controller and/or components thereof), a train control system, and/or one or more airbrake retention devices (e.g., one or more components of an airbrake device and/or system), or any combination thereof. In some non-limiting embodiments, one or more devices of a railcar airbrake arrangement 100, head-end brake controller 112, and/or one or more devices (e.g., one or more devices of a system of) air retainer device 142 may include at least one device 400 and/or at least one component of device 400. As shown in FIG. 4, device 400 may include bus 402, processor 404, memory 406, storage component 408, input component 410, output component 412, and communication interface 414.

Bus 402 may include a component that permits communication among the components of device 400. In some non-limiting embodiments, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include a random access memory (RAM), a read only memory (ROM), and/or another type of dynamic or static storage device (e.g., flash memory, magnetic memory, optical memory, etc.) that stores information and/or instructions for use by processor 404.

Storage component 408 may store information and/or software related to the operation and use of device 400. For example, storage component 408 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.).

Communication interface 414 may include a transceiver-like component (e.g., a transceiver 306) that enables device 400 to communicate with other devices, such as via a wired connection, a wireless connection, or a combination of wired and wireless connections. Communication interface 414 may permit device 400 to receive information from another device and/or provide information to another device.

Device 400 may perform one or more processes described herein. Device 400 may perform these processes based on processor 404 executing software instructions stored by a computer-readable medium, such as memory 406 and/or storage component 408. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 4 are provided as an example. In some non-limiting embodiments, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

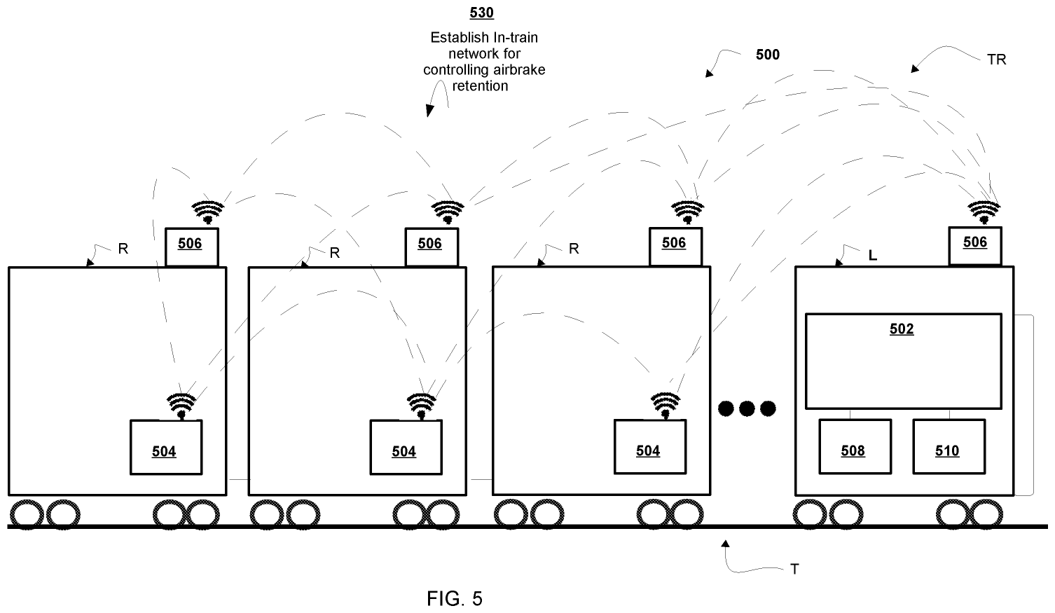

Referring now to FIG. 5, FIG. 5 is a diagram of a train system 500 that may include a head-end controller 502 to establish an in-train network for controlling airbrake retention as shown by reference number 530. In some non-limiting embodiments, the airbrake retention device 504 for each railcar may also be controlled by the operator from the head-end controller 502 that transmits data signals over the in-train network (or a wireless mesh network), which may extend the in-train network throughout the train. Based upon the nature and content of the alarm, the operator can manually control the train TR to achieve a safe situation, or alternatively, the system 500 may be configured, adapted, or programmed to automatically implement or enforce such control through a control system 552.

In some non-limiting embodiments and in order to obtain appropriate data and information from remote locations, system 500 (whether local to the railcar R or local on the train TR (e.g., as part of a control system (such as head-end controller 502) or airbrake retention device 504) may include a communication node (e.g., in-train communication node 506 or a self-identifying node of air retention device 504). The communication node 506 and airbrake retention device 504 may receive train control data, such as airbrake data and/or some other train or track data, thereby ensuring that the most accurate data is available to the head-end controller 502 for determining airbrake retention. The communication node 506 may include a transceiver (e.g., a device capable of receiving and/or transmitting wireless signals) and/or a receiver capable of receiving hard-wired (e.g., trainline TL and/or rail-based signals). The communication node 506 may obtain data from a variety of sources (e.g., a central dispatch system, a wayside unit, a wayside-based detection system, an off-board database, and the like).

In some non-limiting embodiments, information from the communication node 506 and/or other train data can be used to make determinations regarding the use of the airbrake retention device 504 of specific railcars R. This provides a managed approach to be used as to the brake cylinder air retention of railcars R. Furthermore, deciding between the braking systems of different cars can also be part of the decision-making process based upon the grade of the track T.

In some non-limiting embodiments, the air retention device 504 may be set to prevent air from venting from a railcar brake cylinder (e.g., brake cylinder 128, as shown in FIG. 1) allowing for a railcar to retain braking force even when the brake pipe rises. In order to recover brakes for a train on a grade, one or more air retention devices 504 must be set to hold the train as brakes are released, but not too many so as to prevent the train from being able to move under locomotive power. After the train has cleared the grade, all air retention devices 504 are restored to the venting position and normal operations ensue.

In some non-limiting embodiments, the process of recovering a train on a grade is very time consuming and causes interruptions in train movement with ripple effects through the railroad network. For example, air retention device 504 may be operated (e.g., set or released) so that crew members do not have to walk the train to manually operate other manual valves. This will also likely be a key issue for any railroad intending to go to a single person crew.

In some non-limiting embodiments, air retention device 504 (e.g., an electro/pneumatic retaining valve that may be controlled from the cab of the locomotive) would be installed on freight cars in series with the existing manual retaining valves and would allow holding and releasing of the Brake Cylinder Pressure (BCP) air remotely.

In some non-limiting embodiments, the air retention device 504 may include a valve type (e.g., pilot, shuttle, etc.) that may rely on air pressure rather than electrical power for movement of the valve. In this way, electrical power requirements are minimal with pneumatics doing the work. The pilot air would be received from the brake cylinder (e.g., brake cylinder 128, as shown in FIG. 1), thus, insuring the valve could only be engaged when brakes have been applied.

In some non-limiting embodiments, the brake cylinder (e.g., brake cylinder 128) may receive signals from a network (e.g., wireless in-train network) between the locomotive and participating vehicles (e.g., railcars having participating nodes 506, head-end controller 502, and/or air retention devices 504). This network may rely on self-identifying mesh network technology, as in nodes 506, where low power peer to peer communication is established. In some non-limiting embodiments, railcars that are equipped with nodes 506 may identify themselves to the network and help relay data to nearby members (e.g., nodes 506). In some non-limiting embodiments, air retention device 504 may be controlled to identify on the network via some control/wake-up signal, such as a deliberate BPP cycle, that only vehicles in that train detect as opposed to other nearby trains. For example, once the vehicles are identified to the head-end (e.g., head-end controller 502), commands may be issued to control (e.g., to set, release, awaken, and/or identify, etc.) the retaining valve. In some non-limiting embodiments, a positive feedback response would be required to ensure a particular car has honored the command and it would feed back its state. Once feedback had been obtained that the desired number of cars had set their air retention devices 504, the crew could safely release the train brakes and proceed down the hill.

In some non-limiting embodiments, a positive train control system (PTC) may supply a braking algorithm. For example, PTC may provide guidance as to how many air retention devices 504 are necessary (e.g., to set, activate, identify, and/or operate) for current and future grade forces. For example, head-end controller 502 may receive track information from PTC via its track database, including train weight and the amount of braking force necessary to compensate. In some non-limiting embodiments, during descent, the PTC may continue to provide guidance on when retainers may be released based on decreasing grade conditions.

In some non-limiting embodiments, advantages of air retention device 504 may be received during descent of a track with grade conditions. For example, as the grade lessens, the crew and/or head-end controller 502 may individually control each air retention device 504 allowing for release of only a few cars (e.g., a number of cars to balance braking force against the lessening grade). For example, as the air pressure of the train T is fully recharged or reaches flat grade, the crew may command all remaining valves to release. In some non-limiting embodiments, the entire release process may be accomplished without stopping. The advantages of using a system for controlling air retention device 504 may provide an increased efficiency and throughput for the railroad in such circumstances. In some non-limiting embodiments, the advantages may also increase crew safety. For example, crew safety may increase by avoiding walking near or on a portion of the train to manually operate retaining valves. In some non-limiting embodiments, the crew may avoid uneven terrain or harsh weather conditions.

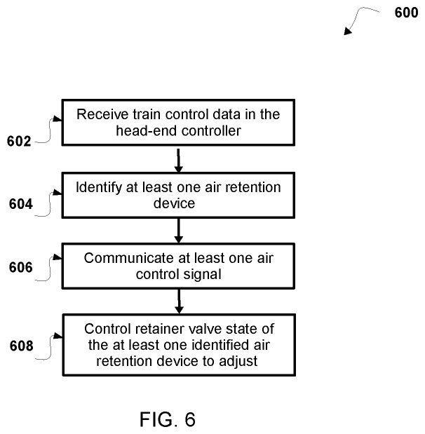

Referring now to FIG. 6, FIG. 6 is a flowchart of a non-limiting embodiment of a process 600 for airbrake retention for controlling air flow within an airbrake system. In some non-limiting embodiments, one or more of the steps of process 600 may be performed (e.g., completely, partially, etc.) by head-end controller 502 (e.g., one or more devices of head-end controller 502). In some non-limiting embodiments, one or more of the steps of process 600 may be performed (e.g., completely or partially) by another device or a group of devices separate from or including head-end controller 502, such as railcar airbrake arrangement 100 (e.g., one or more devices of railcar airbrake arrangement 100), on board.

As shown in FIG. 6, at step 602, process 600 includes receiving train control data in the head-end controller unit, the train control data associated with a control input for operating the airbrake system of a train in a track segment including a grade (e.g., traveling on a graded railway). The head-end controller 502 may make a determination about stopping or starting the train based on the train control data. For example, head-end controller 502 receives train control data preferably including an air pressure in at least one component of the railcar airbrake arrangement 100.

In some non-limiting embodiments, the head-end controller 502 receives train control data comprising track data associated with a geographical area. The head-end controller 502, may receive information from a track database containing a variety of data including geographical coordinates of a number of trackside features that are disposed along the railway tracks, as well as a unique identifier for each of the trackside features. For example, head-end controller 502 receives train control data that includes map data preferably including positions of wayside signals, switches, grade crossings, stations, and the like. The map data preferably also includes information concerning the direction and grade of the track.

In some non-limiting embodiments, head-end controller 502 receives train control data that preferably includes information associated with the main reservoir pressure, brake pipe pressure, and brake cylinder pressure. In some non-limiting embodiments, the head-end controller 502 is in communication with a head of train (HOT) device and an end of train (EOT) device. The head-end controller 502 may receive further train control data from the HOT and EOT, such as GPS location information for any car on the train.

In some non-limiting embodiments, head-end controller 502 receives train control data that preferably includes route network data associated with a series of interconnected route segments and a set of routing rules on which the train may travel. The routing rules include speed restrictions for each route segment. In an embodiment used with trains and locomotives, the database may include a track network made of interconnecting track segments and locations of stations in the track network and the track segments at the stations for entering and exiting a station.

In some aspects, the train control data may include air pressure over time in at least one component of the railcar airbrake arrangement 100, air leakage in the railcar airbrake arrangement 100, air leakage rate in the railcar airbrake arrangement 100, brake holding prediction data, air level data, and the like. In addition, braking data, train data, track data, position data, and the like, may be received from a train control system (e.g., a local controller, a central controller, a remote controller, or a remote database). In some non-limiting embodiments, the head-end controller 502 is in communication with a train control system.

In some non-limiting embodiments, the head-end controller 502 may store the train control data or build models based on data (e.g., a virtual model of the track of the train). The head-end controller 502 may store historical data about one or more components of one or more of the railcars R of the train TR from which models can be generated. Therefore, any important braking or train control information can be communicated to the train TR for use in making train control decisions. Still further, at least a portion of this additional information, such as in the form of airbrake data, airbrake arrangement condition, control data, operational data, and the like may be transmitted or communicated to the head-end controller 502, from a remote controller, at least one other central controller, a vehicle controller, an on-board controller of a locomotive L, a central dispatch system, and the like. Any number of communication paths and data transfer processes are envisioned within the context and environment of the present invention, such that the appropriate train control decisions can be made.

In some non-limiting embodiments, head-end controller 502 may be in the form of, integrated with, or replaced with an existing controller. Such systems often rely upon various databases and on-board analyses to provide the operator with accurate train control information, as well as to confirm safe train operation. Accordingly, the head-end controller 502 of the present invention may be integrated and/or replaced with such a known on-board controller.

As further shown in FIG. 6, at step 604, process 600 includes identifying at least one air retention device of the airbrake system based on the train control data. For example, head-end controller 502 receives guidance from a positive train control (PTC) that monitors and controls the movements of the train TR. In some aspects, head-end controller 502 determines control of one or more air retention controllers 302 based on information about the trains location, (e.g., maximum speed limits and where it is allowed to safely travel). For example, the head-end controller 502 determines control of one or more air retention controllers 302 for enforcing a limit to prevent unsafe movement. In some cases, the head-end controller 502 determines activation or release of one or more air retention controllers 302 for enforcing a limit to prevent unsafe movement. In some aspects, head-end controller 302 applies information from a PTC system, to apply a braking algorithm for determining activation or release of one or more air retention controllers 302 for enforcing a limit.

In some non-limiting embodiments, head-end controller 502 may be programmed or configured to identify a set of one or more retention controllers 302 to control based on a review of speeds, track conditions, and vehicle locations at a safe speed and acceleration for a train or bring a train to a safe stop. In some aspects, the head-end controller 502 may be programmed or configured to apply a braking algorithm to determine the number of air retention controllers 302 necessary to control for traversing a particular railway. In some aspects, the head-end controller 502 applies guidance based on current and future grade forces via a track database, train weight and the amount of braking force necessary to compensate. In some aspects, the head-end controller 502 determines that one or more retainer valves are necessary before or during a descent. In some cases, the head-end controller 502 can determine when air retention controllers 302 can be released as the grade conditions change.

In some non-limiting embodiments, the head-end controller 502 determines that the grade is decreasing (e.g., lessening), either based on internal data or guidance from a PTC system. The head-end brake controller 502 controls the determination in the number of retainer valves that could result in a decreased number of retaining valves. The present method provides the advantage that as the grade lessens, the head-end controller 502 can individually control each retaining valve allowing for gradual release of just a few cars to balance braking force against the lessening grade. Once the train is fully recharged or reaches flat grade, the head-end controller 502 can command all remaining valves to release. The head-end controller 502 can perform the entire release process while the train is traversing a route. The method increases efficiency throughput for the railroad in these circumstances. The head-end brake controller 502 performs the operation, therefore, the method would also increase crew safety by eliminating manual set/release of retainer valves, including eliminating walking a portion of the train to manually set/release the retaining valves on uneven terrain or in harsh weather conditions.

In some non-limiting embodiments, the head-end controller 502 determines a desired number of railway cars associated with a braking event, wherein the desired number of railway cars are associated with a number of air retention devices 302 (e.g., retainer valves) to prevent a runaway condition on a grade.

As further shown in FIG. 6, at step 606, process 600 includes communicating at least one air control signal from the head-end controller unit to the at least one identified air retention device, the at least one identified air retention device comprising a controller to receive a control signal and a valve to control exhaust release from the at least one airbrake cylinder, wherein the air control signal includes instructions for at least one identified air retention device. For example, the head-end controller 502 communicates with an air retention controller 302 based on an air control signal, the air control signal comprising information associated with an airbrake cylinder 128 of a braking assembly.

In some non-limiting embodiments, head-end brake controller 502 communicates with air retention controllers 302 based on signals of a wireless in-train network between the locomotive and participating railcars. For example, the head-end brake controller 502 communicates with one or more railcar brake systems that include one or more air retention devices 212 associated with one or communication devices 414 for transmitting and receiving air control signals from the head-end controller. In some aspects, the head-end controller 502 communicates wirelessly with one or more air retention devices 212 that include one or more retainer valves for a railcar (e.g., pneumatically actuated pilot valve), one or more air retention controllers 302 (e.g., control single processor and memory), and one or more communication devices 414 (e.g., antenna).

In some non-limiting embodiments, head-end controller 502 communicates with an air retention controller 302 based on an air control signal for retention data. For example, the head-end controller 502 communicates retention data, the retention data based on retention information associated with an action for adjusting the retainer valve from a release state to a hold state to prevent the flow of air between the main reservoir 106 and the air braking cylinder 128.

In some non-limiting embodiments, the head-end controller 502 communicates release data, the release information associated with an action for adjusting the retainer valve from a hold state to a release state to allow air flow between the reservoir and the air braking cylinder. In some aspects, the head-end controller 502 communicates wake-up data, the wake-up data associated with information for awakening a retainer valve from a stand-by state and triggering a timer value activation for indicating an active state.

In some non-limiting embodiments, head-end controller 502 may communicate a power control signal to one or more air retention controllers. For example, head-end controller 502 may communicate an air control signal for providing a stand-by state to manage power consumption of the at least one retaining valve. For example, head-end controller 502 transmits a stand-by state signal to induce an airbrake retention device 504 to place itself in a sleep state. In some aspects, the head-end controller 502 may communicate wake-up data, the wake-up data associated with an action for awakening a retainer valve from a stand-by state and triggering a timer value activation for indicating an active state. In some aspects, head-end controller 502 transmits an air control signal for awakening the at least one retaining valve to receive control signals based on reaching a brake pressure threshold value.

In some non-limiting embodiments, head-end controller 502 may receive guidance from a positive train control (PTC), head-end controller 502 may then communicate retainer valve data to one or more airbrake retention devices 504 based on a brake force prediction. In some aspects, head-end controller 502 receives a brake force prediction from a train control system associated with at least one upcoming area (e.g., geographic area of a track) based on external conditions and train control factors. In some aspects, the head-end controller 502 communicates air control signal based on performance of additional steps. In some aspects, the head end controller 502 communicates, in response to receiving, information based on determining if an actual grade exists and predicting a number of retainer valve nodes that should be activated based on a statistical analysis of said collected data. For example, the head-end controller 502 communicates a control message to one or more airbrake retention devices 504 to limit or prevent unsafe movement of the train. In some cases, the head-end controller 502 communicates to activate or release one or more airbrake retention devices 504 simultaneously for enforcing a limit to prevent unsafe movement. In some aspects, head-end controller 502 applies information from a PTC system while communicating based on a braking algorithm for determining one or more airbrake retention devices 504 for enforcing a limit.

In some non-limiting embodiments, head-end controller 502 automatically communicates an air control signal to a retainer valve when approaching a grade based on train control data.

As further shown in FIG. 6, at step 608, process 600 includes controlling a valve state of the at least one identified air retention device to adjust from a first state to a second state based on the air control signal, wherein the first state represents a vent state, to allow exhaust from the airbrake cylinder, and the second state represents a hold state, to retain air flow exhaust in the at least one airbrake cylinder. For example, the head-end controller 502 controls the retainer valve to adjust from a first state to a second state based on the air control signal to control air flow between the main reservoir 106 and the air braking assembly. In some aspects, head-end controller 502 controls the airbrake retention device 504 to receive air pressure for moving the retainer valve from a release state to a hold state. For example, head-end controller 502 may communicate an electronic signal to actuate the air retention device 212 to be activated to receive pneumatic pressure capable of configuring the retainer valve.

In some non-limiting embodiments, head-end controller 502 may receive guidance from a positive train control (PTC) that monitors and controls the movements of the train TR, head-end controller 502 controls a retainer valve of one or more airbrake retention devices 504 based on a brake force prediction. For example, head-end controller 502 receives a brake force prediction from a train control system associated with at least one upcoming area (e.g., geographic area of track) based on external conditions and train control factors.

In some non-limiting embodiments, the head-end controller 502 controls air control signal based on performance of additional steps. In some aspects, the head end controller 502 controls, in response to receiving, information based on determining if an actual grade exists and predicting a number of retainer valve nodes that should be activated based on a statistical analysis of said collected data. For example, the head-end controller 502 controls with a control message sent to one or more airbrake retention devices 504 to limit or prevent unsafe movement of the train. In some cases, the head-end controller 502 communicates to activate or release one or more airbrake retention devices 504 simultaneously for enforcing a limit to prevent unsafe movement. In some aspects, head-end controller 502 applies information from a PTC system while communicating based on a braking algorithm for determining one or more airbrake retention device 504 for enforcing a limit.

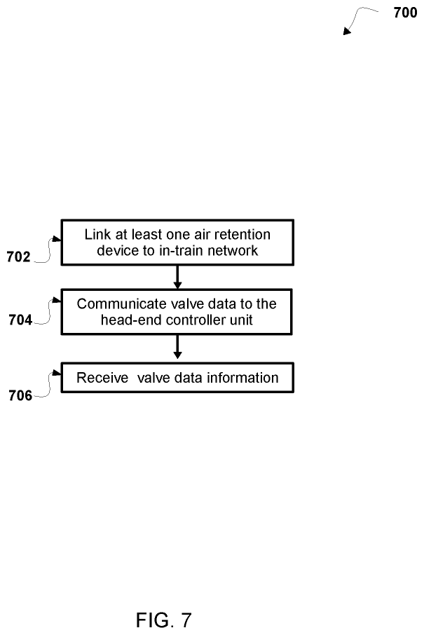

Referring now to FIG. 7, FIG. 7 is a flowchart of a non-limiting embodiment of a process 700 for airbrake retention for controlling air flow within an airbrake system. In some non-limiting embodiments, one or more of the steps of process 700 may be performed (e.g., completely, partially, etc.) by head-end controller 502 (e.g., one or more devices of head-end controller 502). In some non-limiting embodiments, one or more of the steps of process 700 may be performed (e.g., completely, partially, etc.) by another device or a group of devices separate from or including head-end controller 502, such as railcar airbrake arrangement 100 (e.g., one or more devices of railcar airbrake arrangement 100), airbrake retention device 504 (e.g., one or more devices of airbrake retention device 504), or self-identifying node 515 of a wireless in-train network.

As shown in FIG. 7, at step 702, process 700 includes linking an in-train network comprising a plurality of self-identifying nodes, the self-identifying nodes associated with one or more air retention controllers of a brake arrangement. For example, head-end controller 502 may signal a self-identifying node on a wireless in train network between the locomotive and participating vehicles. In some aspects, an in-train network applies existing self-identifying mesh network technology to establish low power peer to peer communication.

In some non-limiting embodiments, head-end controller 502 forms a link between one or more nodes of railcars that self-identify. For example, head-end controller 502 receives identifiers from the self-identifying nodes. The head-end controller 502 links them to the in-train network to provide relay data to nearby nodes. This is usually done via some control/wake-up signal, such as a deliberate BPP cycle, that only vehicles in that train detect as opposed to other nearby trains.

As shown in FIG. 7, process 700 includes at step 704, communicating to one or more of the self-identifying nodes, valve data from the head-end controller unit to the at least one air retention device, the valve data comprising destination information, wherein the destination information identifies the head-end controller. In some non-limiting embodiments, process 700 includes communicating valve data associated with one or more airbrake retention devices 504 between nodes to form a path from a head-end controller 502, the data comprising self-identifying information associated with the at least one airbrake retention device 504. For example, head-end controller 502 receives data associated with an airbrake retention device 504 from a first retaining valve through one or more intermediate self-identifying nodes until the data reaches the head-end brake controller 502. In some aspects, the head-end controller 502 receives a signal transmitted through at least one of the one or more intermediate self-identifying nodes that comprise a second retaining valve.

In some non-limiting embodiments, head-end controller 502 stores identifications for nodes. For example, head-end controller 502 stores vehicle nodes, brake cylinder nodes, and other component nodes. Head-end controller 502 may issue commands to set and release the retaining valve 140.

In some non-limiting embodiments, in response to receiving a positive feedback response required for verifying a completed command, head-end controller 502 could ensure that a command is completed by a node. For example, the head-end controller 502 receives a nodes status update. For example, head-end controller 502 processes an action from a set of actions for controlling a setting for a retainer valve. In some aspects, head-end controller 502 adjusts a status associated with at least one retainer valve based on at least one action associated with an updated status of the at least one retainer valve.

In some non-limiting embodiments, head-end controller 502 receives feedback to determine that the desired number of cars has set their retention control devices 212 for safely releasing the train brakes to proceed down the hill.

In some non-limiting embodiments, head-end controller 502 communicates (e.g., receives or transmits) routing information to one or more retaining valve nodes. In some non-limiting embodiments, head-end controller 502 determines a further action if the data is addressed to an intermediate self-identifying node 515. For example, head-end controller 502, if the data is addressed to an intermediate self-identifying node, identifies a final destination for an air control signal.

As shown in FIG. 7, process 700 includes at step 706, receiving valve data in the head-end controller unit from at least one of the one or more self-identifying nodes, wherein the valve data identifies the at least one air retention device. In some non-limiting embodiments, process 700 includes storing the received self-identifying information associated with the at least one retainer valve that includes identification information for identifying the retainer valve node for communicating on the in-train network, where the identification information is associated with a retention control setting of a retainer valve. For example, head-end controller 502 stores the self-identifying information associated with the at least one retainer valve, airbrake cylinder, or railcar that includes identification information for identifying the retainer valve node for communicating on the in-train network, where the identification information is associated with a retention control setting of a retainer valve.

In some non-limiting embodiments, process 700 includes determining a dynamic routing algorithm based on in-train parameters to route messages from the head-end brake controller to a retaining valve node of the mesh network. For example, head-end controller 502 communicates an air control signal to each retainer valve node within a group of rail cars in a train. For example, head-end controller 502 determines an action if the data is addressed to the receiving retaining valve node.

In some non-limiting embodiments, process 700 includes grouping one or more retainer valves of the in-train network into a logical association of rail-way cars. For example, head-end controller 502 outputs a representation of the grouping of one or more retainer valves and associated status. For example, head-end controller 502 segments one or more retainer valves into groups based on location on a train. In some aspects, head-end controller 502 segments one or more retainer valves based on a location in a railcar.

In some non-limiting embodiments, head-end controller 502 groups an action from a set of actions for controlling a setting for a retainer valve. For example, head-end controller 502 provides a grouping based on information associated with a status of at least one retainer valve based on at least one action associated with a status.

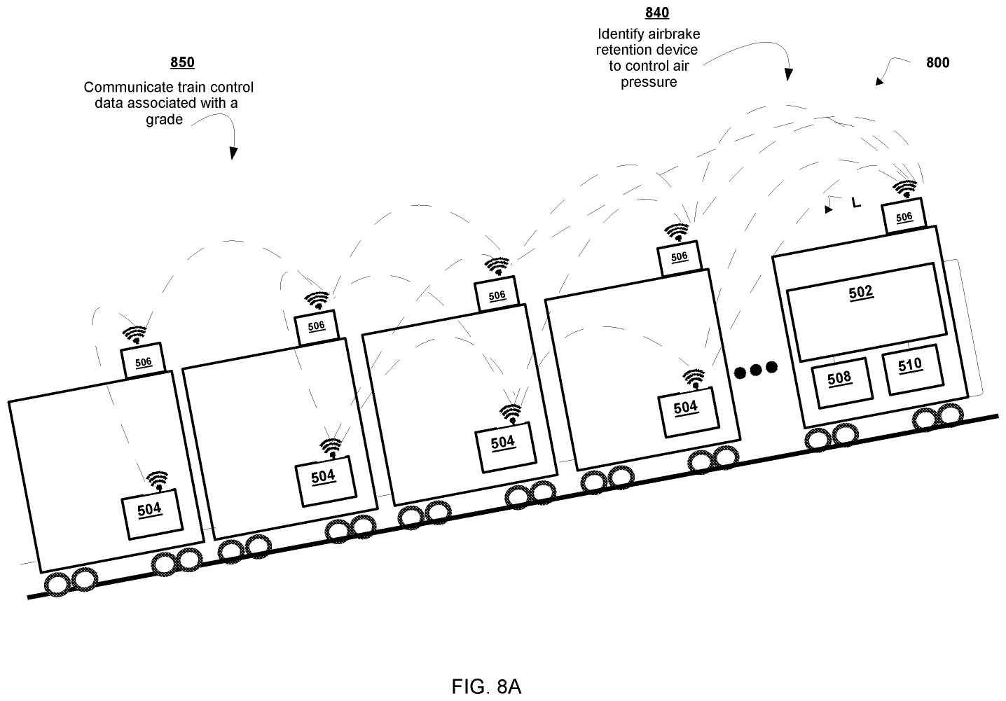

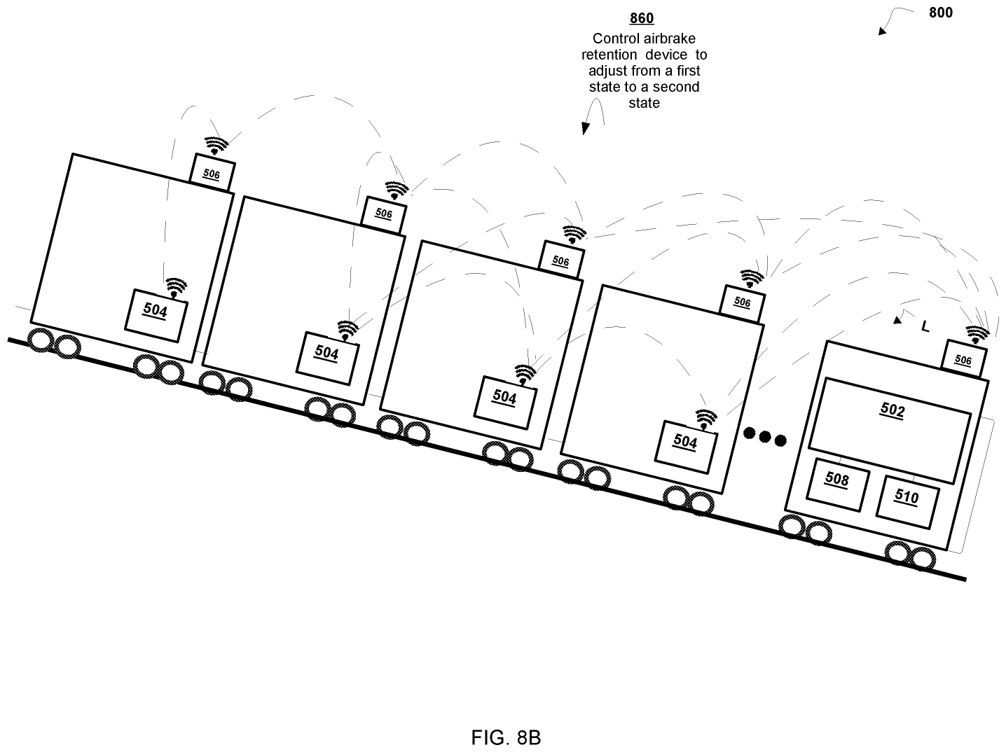

Referring now to FIGS. 8A-8B, FIGS. 8A-8B are diagrams of an overview of a non-limiting embodiment of an implementation 800 relating to a process for controlling air flow within an airbrake system. As shown in FIGS. 8A-8B, implementation 800 may include certain railcars R of the train TR traversing a substantially flat grade of the track T that becomes a sloped grade, first in an upward slope and ending in a substantially downward sloped grade of the track T. Among other considerations, the slope or grade of the track T can be used to make decisions about how many brakes must be controlled to maintain the train on an upcoming grade. Further, information from a head-end controller can be used to make determinations regarding the use of the brake air retention devices of specific railcars R. This provides a managed approach to be used for when brake air retention devices of a railcar R should be deployed. Furthermore, deciding between the brake retention devices of different cars can also be part of the decision-making process based upon the grade of the track T.

As shown in FIG. 8A, the head-end controller 502 operates an in-train network for controlling one or more airbrake retention devices 504.

As shown by reference number 840 in FIG. 8A, head-end controller 502 communicates signals to the one or more air retention device 504 to control air pressure. In some cases, the head-end controller 502 determines to activate or release one or more airbrake retention devices 504 for enforcing a limit to prevent unsafe movement. In some aspects, head-end controller 502 applies information from a PTC system, to apply a braking algorithm for determining to activate or release one or more air retention controllers 112 for enforcing a limit.

As shown by reference number 850 in FIG. 8A, head-end controller 502 communicates train control data associated with a grade. In some non-limiting embodiments, the head end unit communicates signals in response to receiving grade information based on determining if an actual grade exists, and predicting a number of retainer valve nodes that should be activated based on a statistical analysis of said collected data. For example, the head-end controller 502 communicates a control signal to one or more airbrake retention devices 504 in order to limit or prevent unsafe movement of the train. In some cases, the head-end controller 502 communicates control signals to control (e.g., activate or release) one or more airbrake retention devices 504 alone or simultaneously to prevent unsafe movement. In some aspects, head-end controller 502 applies information from a Positive Train Control (PTC) system while communicating based on a braking algorithm for determining one or more airbrake retention devices 504 for enforcing a limit.

As shown by reference number 860 in FIG. 8B, head-end controller 502 controls the air retention devices 504 to adjust from a first state to a second state. In some non-limiting embodiments, the grade information based on a truck grade is used in making a braking decision. For example, one or more of the main reservoirs 106 can supply or deliver air to the brake cylinder 128 (and, thus, appropriately apply the brakes), based on the track T as an additional factor in making an accurate determination. For example, the head end controller 502, in response to receiving, information based on determining if an actual grade exists, may determine a number of retainer valve nodes that should be activated based on a statistical analysis of said collected data. For example, the head-end controller 502 communicates a control signal to one or more airbrake retention devices 504 to limit or prevent unsafe movement of the train. In some cases, the head-end controller 502 communicates a control signal to activate or release one or more airbrake retention devices 504 simultaneously for enforcing a limit to prevent unsafe movement. In some aspects, head-end controller 502 applies information from a PTC system while communicating based on a braking algorithm for determining one or more air brake retention devices 504 for enforcing a limit.

The foregoing disclosure provides illustration and description, but is not intended to be exhaustive or to limit the implementations to the precise form disclosed. Modifications and variations are possible in light of the above disclosure or may be acquired from practice of the implementations.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features can be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. An airbrake cylinder retention method for a train equipped with an airbrake system and comprising at least one locomotive, at least one head-end controller unit, a brake pipe, and at least one brake cylinder, comprising:
receiving, with at least one processor, train control data in the head-end controller unit, the train control data associated with a control input for operating the airbrake system of the train in a track segment including a grade;
identifying, with at least one processor, at least one air retention device of the airbrake system based on the train control data;
communicating, with at least one processor, at least one air control signal from the head-end controller unit to the at least one identified air retention device, the at least one identified air retention device comprising a controller to receive a control signal and a valve to control exhaust release from the at least one airbrake cylinder, wherein the air control signal includes instructions for the at least one identified air retention device; and
controlling, with at least one processor, a valve state of the at least one identified air retention device to adjust from a first state to a second state based on the air control signal, wherein the first state represents a vent state, to allow exhaust from the airbrake cylinder, and the second state represents a hold state, to retain air flow exhaust in the at least one airbrake cylinder.

2. The airbrake cylinder retention method of claim 1, wherein identifying the at least one air retention device of the airbrake system, further comprises:
linking, with at least one processor, the at least one air retention device to an in-train network comprising a plurality of self-identifying nodes, the self-identifying nodes coupled to the head-end controller unit;
communicating to one or more of the self-identifying nodes, valve data from the head-end controller unit to the at least one air retention device, the valve data comprising destination information, wherein the destination information identifies the head-end controller; and
in response to communicating the valve data, receiving, with at least one processor, valve data in the head-end controller unit from at least one of the one or more self-identifying nodes, wherein the valve data identifies the at least one air retention device.

3. The airbrake cylinder retention method of claim 2, wherein communicating valve data from the head-end controller unit to the at least one air retention device further comprises:
transmitting, with at least one processor, valve data from the at least one air retention device to a second air retention device, the second air retention device, configured to:
determine an intermediate self-identifying node of the one or more of the self-identifying nodes;
communicate the valve data to the intermediate self-identifying node.

4. The airbrake cylinder retention method of claim 1, wherein the at least one identified air retention device comprises a stand-by state, the method further comprising:
receiving, with at least one processor, an air control signal from the head-end controller unit, the air control signal comprising information associated with awakening the at least one air retention device from the stand-by state;
in response to receiving the air control signal:
generating, with at least one processor, a predetermined duration for active communication; and
enabling operation, with at least one processor, of the controller of the at least one identified air retention device based on the air control signal and the predetermined duration for active communication.

5. The airbrake cylinder retention method of claim 1, further comprising:
generating, with at least one processor, a logical association of one or more railway cars with the at least one air retention device;
processing, with at least one processor, control input for operating the at least one air retention device in the logical association;
adjusting, with at least one processor, a status in the head-end controller unit associated with the at least one air retention device based on the control input; and
outputting, with at least one processor, a representation of the logical association of the at least one air retention device and status.

6. The airbrake cylinder retention method of claim 5, wherein determining the at least one air retention device for controlling air flow within the airbrake system to prevent air pressure release based on the train control data further comprises:
determining, with at least one processor, one or more railway cars associated with a braking event, wherein the one or more railway cars are associated with the at least one air retention device to prevent a runaway condition on the grade.

7. The airbrake cylinder retention method of claim 1, wherein the train control data includes a brake force prediction from a train control system associated with at least one upcoming track segment based on external conditions and train control factors, the method further comprising:
predicting a threshold number of air retention device self-identifying nodes to activate based on the train control data; and
communicating, with at least one processor, at least one air control signal to one or more air retention devices based on the brake force prediction.

8. The airbrake cylinder retention method of claim 6, automatically controlling the at least one air retention device when approaching a grade based on train control data.

9. The airbrake cylinder retention method of claim 1, further comprising:
communicating, with at least one processor, a sleep signal from the head-end unit to the at least one air retention device, the sleep signal activating a stand-by state of the controller of the at least one retaining valve;
awakening, with at least one processor, the at least one retaining valve to receive control signals based on reaching a brake pressure threshold value.

10. The airbrake cylinder retention method of claim 1, wherein controlling the at least one air retention device to adjust from the first state to the second state is based on air pressure for pneumatically moving the at least one air retention device from a release state to a hold state.

11. An airbrake retention system for a train equipped with an airbrake system and comprising at least one locomotive, a brake pipe coupled to at least one railcar, at least one airbrake cylinder, and an exhaust pipe from the airbrake cylinder, the system comprising:
a wireless head-end controller unit programmed or configured to:
receive train control data associated with a control input for operating the airbrake system of a train in a track segment including a grade;
identify at least one air retention device based on the train control data; and
communicate at least one air control signal to the at least one identified air retention device; and
the at least one air retention device, comprising:
a pneumatically adjustable valve portion coupled to the exhaust pipe of the airbrake cylinder to control exhaust release from the at least one airbrake cylinder; and
a controller comprising at least one processor, the controller programmed or configured to:
receive an air control signal including instructions for adjusting a state of the at least one identified air retention device; and
control a valve state of the pneumatically adjustable valve portion to adjust from a first state to a second state based on the air control signal, wherein the first state represents a vent state to allow exhaust from the airbrake cylinder, and the second state represents a hold state to retain air flow exhaust in the at least one airbrake cylinder.

12. The airbrake retention system of claim 11, wherein the train further comprises an in-train network, the controller of the at least one air retention device is further programmed or configured to:
link the at least one air retention device to the in-train network comprising a plurality of self-identifying nodes, the self-identifying nodes coupled to the head-end controller unit;
wherein, the wireless head-end controller unit programmed or configured to:
communicate valve data from the head-end controller unit to the at least one air retention device, the valve data comprising destination information, wherein the destination information identifies the head-end controller; and
in response to communicating the valve data, receive valve data in the head-end controller unit from at least one of the one or more self-identifying nodes, wherein the valve data identifies the at least one air retention device.

13. The airbrake retention system of claim 12, wherein the wireless head-end controller unit is coupled to the in-train network, the wireless head-end controller unit when identifying the at least one air retention device of the airbrake system is further programmed or configured to:
receive valve data in the head-end controller unit from one or more self-identifying nodes of the in-train network, wherein the valve data identifies the at least one air retention device.

14. The airbrake retention system of claim 11, wherein the at least one air retention device comprises a stand-by state, the at least one air retention device further programmed or configured to:
receive an air control signal from the head-end controller unit, the air control signal comprising information associated with awakening the at least one air retention device from the stand-by state;
in response to receiving the air control signal:
generate, with at least one processor, a predetermined duration for active communication; and
enable operation of the controller of the at least air retention device based on the air control signal and the predetermined duration for active communication.

15. The airbrake retention system of claim 13, the wireless head-end controller unit is further programmed or configured to:
generate a logical association of one or more railway cars with the at least one air retention device;
process control input for operating the at least one air retention device in the logical association;
adjust a status in the head-end controller unit associated with the at least one air retention device based on the control input; and
output a representation of the logical association of the at least one air retention device and status.

16. The airbrake retention system of claim 11, wherein the head-end controller unit, when determining the at least one air retention device for controlling air flow within an airbrake system, is further programmed or configured to:
determine one or more railway cars associated with a braking event, wherein the one or more railway cars are associated with the at least one air retention device to prevent a runaway condition on the grade.

17. The airbrake retention system of claim 11, wherein the train control data includes a brake force prediction from a train control system associated with at least one upcoming track segment based on external conditions and train control factors, the wireless head-end controller unit is further programmed or configured to:
predict a threshold number of air retention device self-identifying nodes to activate based on the train control data; and
communicate at least one air control signal to one or more air retention devices based on the brake force prediction.

18. The airbrake retention system of claim 17, comprising automatically controlling the at least one air retention device when approaching the grade based on train control data.

19. The airbrake retention system of claim 11, further comprising:
awakening the controller of the at least one air retention device to receive control signals based on reaching a brake pressure threshold value.

20. The airbrake retention system of claim 11, wherein the air retention device is programmed or configured to adjust from the first state to the second state is based on air pressure for pneumatically moving the pneumatically adjustable valve portion of the at least one air retention device from a release state to a hold state.

21. A computer program product for controlling air flow within an airbrake system, comprising:
a first non-transitory computer-readable medium including program instructions that, when executed by at least one processor, causes the at least one processor to:
receive train control data associated;
determine an air retention device within a railcar brake system to control airbrake release based on the train control data; and
communicate an air control signal, the air control signal comprising information associated with the air retention device of an air braking system;
a second non-transitory computer-readable medium including program instructions that, when executed by at least one processor, causes the at least one processor to control at least one air retention device to:
receive an air control signal including instructions for adjusting a state of a pneumatically adjustable valve portion of the at least one air retention device; and
control a valve state of the pneumatically adjustable valve portion to adjust from a first state to a second state based on the air control signal, wherein the first state represents a vent state to allow exhaust from the airbrake cylinder, and the second state represents a hold state to retain air flow exhaust in the at least one airbrake cylinder.
